(19) United States
(12) Patent Application Publication
(10) Pub. No.: US 2026/0346701 A1
(43) Pub. Date: Nov. 5, 2026

(54) Front-End Structure for a Motor Vehicle

(71) Applicant: Bayerische Motoren Werke Aktiengesellschaft, Muenchen (DE)

(72) Inventors: Peter HELL, Moosburg (DE); Manuel SCHROEDER, Oberhaching (DE)

(21) Appl. No.: 19/120,274

(22) PCT Filed: Sep. 18, 2023
(86) PCT No.: PCT/EP2023/075573

§ 371 Date: Apr. 11, 2025

(30) Foreign Application Priority Data
Oct. 14, 2022 (DE) 10 2022 126 993.0

(51) Int. Cl. B60K 11/08; B60K 11/04; B60R 19/34

(52) U.S. Cl. CPC B60K 11/085; B60K 11/04; B60R 19/34

(57) ABSTRACT

A front-end structure for a motor vehicle has a right-hand deformation element in a motor vehicle width direction and a left-hand deformation element in the motor vehicle width direction. A continuous cross member in the motor vehicle width direction connects the right-and left-hand deformation elements to one another and is arranged in front of the right-and left-hand deformation elements in a motor vehicle longitudinal direction. A right-hand vertical strut in the motor vehicle width direction and a left-hand vertical strut in the motor vehicle width direction connect the continuous cross member to another cross member. The vertical struts are each L-shaped when viewed from the motor vehicle longitudinal direction.

### BACKGROUND AND SUMMARY

The present disclosure relates to a front-end structure for a motor vehicle and a motor vehicle having the front-end structure.

Motor vehicles having a front-end structure of the aforementioned type are described in the prior art.

DE 10 2017 124 590 A1 relates to a cross member arrangement for a motor vehicle, having an upper cross member and a cross member arranged therebelow in the installed position, wherein the upper cross member and the lower cross member extend in each case in the motor vehicle transverse direction over a large part of the vehicle width and are coupled together via one respective connecting web which is arranged in the motor vehicle vertical direction, such that the upper cross member and the lower cross member and the connecting webs are manufactured as an extrusion profile in one piece and from the same material.

EP 4 001 022 A1 relates to a bumper arrangement for a motor vehicle, having a cross member which can be coupled to the motor vehicle via crash boxes and which is manufactured as a press-formed component in one piece from the same material, in particular with a hat-shaped cross section. The cross member is configured in one respective end region to run with an orientation obliquely downwardly relative to the motor vehicle vertical direction and the end region is configured to be ring-shaped.

DE 20 2021 103 264 U1 relates to a bumper arrangement for a motor vehicle having an upper main cross member, which can be coupled to the motor vehicle via crash boxes, and a lower auxiliary cross member, wherein the main cross member and the auxiliary cross member are coupled together via vertical struts. The main cross member and the auxiliary cross member run at least in some portions in a curved manner about the vertical axis, wherein the main cross member and the auxiliary cross member have different radii of curvature from one another. The auxiliary cross member is set back relative to the main cross member and oriented toward the motor vehicle in the motor vehicle longitudinal direction. The auxiliary cross member has a central portion which is offset relative to the vertical direction, and the main cross member and the auxiliary cross member are configured with the vertical struts in one piece and from the same material.

Due to changing requirements in the event of a crash, a further development of these conventional structures is required.

Against the background of this prior art, the object of the present disclosure is to provide a device which is suitable for enriching the prior art.

The object is achieved by the features of the independent claim. The dependent claims contain optional developments of the disclosure.

Accordingly, the object is achieved by a front-end structure for a motor vehicle.

A front-end structure can be understood to mean a part of a motor vehicle which is arranged in front of a passenger compartment of the motor vehicle in a motor vehicle longitudinal direction.

The front-end structure comprises a right-hand deformation element in a motor vehicle width direction and a left-hand deformation element in the motor vehicle width direction.

The deformation elements are arranged spaced apart from one another in the motor vehicle width direction. “Left” and “right” refer to a viewing direction from the motor vehicle longitudinal direction. The deformation elements can also be denoted as crash boxes.

The front-end structure comprises a continuous cross member in the motor vehicle width direction, connecting the right-hand and left-hand deformation elements to one another and arranged in front of the right-hand and left-hand deformation elements in a motor vehicle longitudinal direction.

In other words, the continuous cross member is fastened with its rear side in the motor vehicle longitudinal direction both to the left-hand deformation element and to the right-hand deformation element and extends without interruption from the left to the right (or vice versa) between the two deformation elements and optionally beyond the two deformation elements in the motor vehicle width direction.

The continuous cross member can be connected in each case via the deformation elements to a left-hand longitudinal member in the motor vehicle width direction and a right-hand longitudinal member in the motor vehicle width direction, the longitudinal members extending to the rear, i.e. in the direction of the passenger compartment, starting from the respective deformation element in each case in the motor vehicle width direction.

The front-end structure comprises a further cross member. It is contemplated that the further cross member extends substantially parallel to the continuous cross member.

The front-end structure comprises a right-hand vertical strut in the motor vehicle width direction and a left-hand vertical strut in the motor vehicle width direction, connecting the continuous cross member to the respective further cross member.

In other words, the continuous cross member and the further cross member are arranged spaced apart from one another in the motor vehicle height direction and are connected together or to one another, once on the right by the right-hand vertical strut in the motor vehicle width direction and once on the left by the left-hand vertical strut in the motor vehicle width direction.

The respective vertical strut may be screwed and/or welded to the continuous cross member and/or the further cross member.

The vertical struts are configured in each case to be L-shaped, when viewed from the motor vehicle longitudinal direction.

In other words, it is proposed to reduce the vertical struts known from the prior art from a U-shape to an L-shape.

Thus it is possible to prevent the vertical struts or struts for the vertical connection of the cross members leading to an airflow being blocked in the region between a main cooling field formed by a radiator and a brake cooling shaft in front of the air flap control. It can also be achieved that the horizontal struts do not reduce a deformation region in the case of an impact in the lower leg region. A previously required effort for sealing an air guide of the front-end structure with flexible sub-components is also reduced.

Possible developments of the above-described front-end structure are explained hereinafter in detail.

It is contemplated that an upper part of the respective vertical strut extends vertically in the motor vehicle height direction and a lower part of the respective vertical strut extends horizontally in the motor vehicle height direction.

It is also contemplated that, starting from the upper vertical part of the respective vertical strut, the lower horizontal part of the respective vertical strut extends externally to the left or right in the motor vehicle width direction.

The further cross member can be designed in two parts in the motor vehicle width direction. It is contemplated that, starting in each case from a left-hand or right-hand, optionally lower, longitudinal member in the motor vehicle width direction, the further cross member extends to the left or right externally in the motor vehicle width direction.

The lower horizontal part of the respective vertical strut may be attached to the respective left-hand or right-hand part of the two-part cross member.

The front-end structure can comprise a radiator which is arranged between the right-hand and left-hand deformation elements in the motor vehicle width direction.

This radiator can form a so-called main cooling field which can be arranged above the further cross member and/or the continuous cross member in the motor vehicle height direction.

The further cross member can be designed in two parts in the motor vehicle width direction, such that this further cross member is arranged exclusively to the side of the radiator in the motor vehicle width direction.

In other words, the left-hand or right-hand part of the two-part cross member can be arranged entirely to the side of the radiator in the motor vehicle width direction and can be unconnected to one another in the motor vehicle width direction, so that the two-part cross member does not extend in a region which is arranged between the left-hand and the right-hand vertical strut in the motor vehicle width direction. The two-part cross member is thus interrupted in this region.

This can lead to an elimination of a so-called second load path via the further cross member, which usually exists in addition to a so-called first load path via the continuous cross member. This can contribute to further enhancing the above-described effects of the solution according to the disclosure.

The front-end structure can comprise an air flap control and a right-hand air guide in the motor vehicle width direction and a left-hand air guide in the motor vehicle width direction.

The right-hand air guide in the motor vehicle width direction and the left-hand air guide in the motor vehicle width direction can be spaced apart from one another in the motor vehicle width direction.

The air guides can be provided for external radiators or radiators provided in addition to the above-described radiator.

The left-hand vertical strut in the motor vehicle width direction can be arranged in the motor vehicle width direction between the air flap control and the left-hand air guide in the motor vehicle width direction.

The right-hand vertical strut in the motor vehicle width direction can be arranged in the motor vehicle width direction between the air flap control and the right-hand air guide in the motor vehicle width direction.

The air flap control can be arranged below the cross member in the motor vehicle height direction.

The air flap control can be arranged in the motor vehicle width direction between the right-hand air guide in the motor vehicle width direction and the left-hand air guide in the motor vehicle width direction.

The continuous cross member can be arranged above the further cross member in the motor vehicle height direction.

The continuous cross member can be arranged substantially at the same height as the further cross member in the motor vehicle longitudinal direction.

The vertical strut can be arranged in front of the continuous cross member and the further cross member in the motor vehicle longitudinal direction.

The disclosure further relates to a motor vehicle which comprises the above-described front-end structure.

The motor vehicle can be a passenger motor vehicle, such as for example an automobile and/or a utility vehicle, such as for example a truck.

That described above with reference to the front-end structure also applies analogously to the motor vehicle and vice versa.

An embodiment is described hereinafter with reference to FIGS. 1 and 2.

### BRIEF DESCRIPTION OF THE DRAWINGS

FIG. 1 shows schematically and in perspective a front-end structure for a motor vehicle; and

FIG. 2 shows the front-end structure schematically in a plan view, viewed from the front in a motor vehicle longitudinal direction.

### DETAILED DESCRIPTION OF THE DRAWINGS

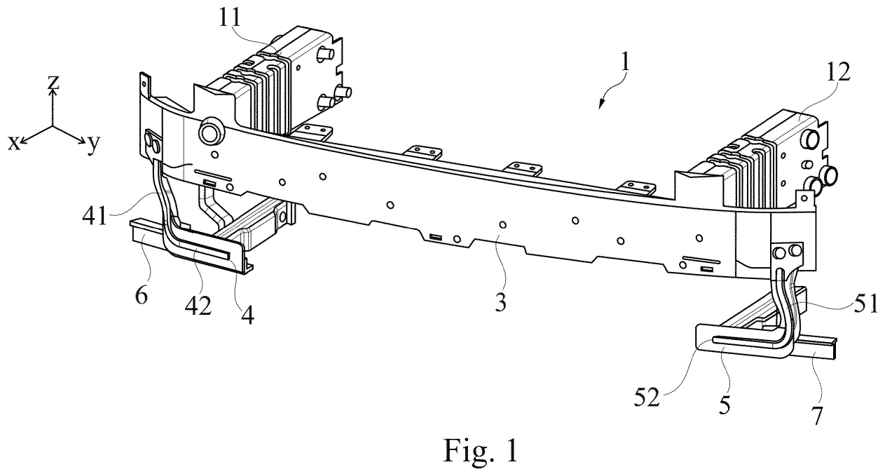

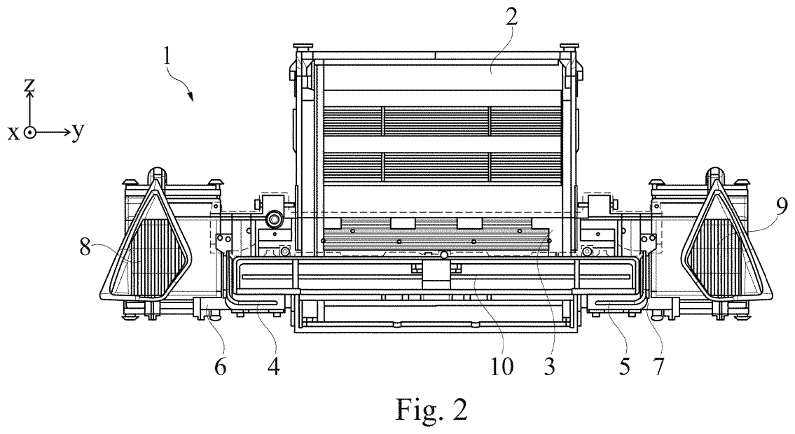

In each case a Cartesian coordinate system is shown in FIGS. 1 and 2. The coordinate system comprises an X-axis, a Y-axis and a Z-axis which in each case enclose an angle of 90° with one another. The X-axis corresponds to a motor vehicle longitudinal direction X, the Y-axis corresponds to a motor vehicle width direction Y and the Z-axis corresponds to a motor vehicle height direction Z. The motor vehicle longitudinal direction X runs from a rear to a front of the motor vehicle, not shown in more detail in FIGS. 1 and 2, i.e. in a main direction of travel of the motor vehicle.

In each case, a front-end structure 1 of the motor vehicle is shown in FIGS. 1 and 2, wherein for greater understanding specific components of the front-end structure are not shown in FIG. 1 but are contained in FIG. 2. Thus the front-end structure 1 is described hereinafter by viewing FIGS. 1 and 2 together.

The front-end structure 1 comprises a right-hand deformation element 11 in the motor vehicle width direction Y and a left-hand deformation element 12 in the motor vehicle width direction Y and a continuous upper cross member 3 in the motor vehicle width direction Y, connecting the right-hand and left-hand deformation elements 11, 12 to one another and arranged in front of both the right-hand and left-hand deformation elements 11, 12 in a motor vehicle longitudinal direction X.

The front-end structure 1 has a radiator 2 which is arranged between the right-hand and left-hand deformation elements 11, 12 in the motor vehicle width direction Y, an air flap control 10 which is arranged below the upper cross member 3 in the motor vehicle height direction Z, and a right-hand air guide 8 in the motor vehicle width direction Y and a left-hand air guide 9 in the motor vehicle width direction Y. The air flap control 10 is arranged in the motor vehicle width direction Y between the right-hand air guide 8 in the motor vehicle width direction Y and the left-hand air guide 9 in the motor vehicle width direction Y.

The front-end structure 1 also has a lower cross member 6, 7 which is arranged below the upper cross member 3 in the motor vehicle height direction Z and on which a right-hand vertical strut 4 is arranged in the motor vehicle width direction Y and a left-hand vertical strut 5 is arranged in the motor vehicle width direction Y, the vertical struts in each case connecting the upper cross member 3 to the lower cross member 6, 7.

The vertical struts 4, 5 are arranged in each case in front of the upper and the lower cross member 3, 6, 7 in the motor vehicle longitudinal direction X.

The vertical struts 4, 5 are configured in each case to be L-shaped, when viewed from the motor vehicle longitudinal direction X, wherein an upper part 41, 51 of the respective vertical strut 4, 5 extends vertically in the motor vehicle height direction Z and a lower part 42, 52 of the respective vertical strut 4, 5 extends horizontally in the motor vehicle height direction Z.

The left-hand vertical strut 5 in the motor vehicle width direction Y is arranged in the motor vehicle width direction Y between the air flap control 10 and the left-hand air guide 9 in the motor vehicle width direction Y and the right-hand vertical strut 4 in the motor vehicle width direction Y is arranged in the motor vehicle width direction Y between the air flap control 10 and the right-hand air guide 8 in the motor vehicle width direction Y.

The lower cross member 6, 7 is designed in two parts in the motor vehicle width direction Y, such that this lower cross member is arranged exclusively to the side of the radiator 2 in the motor vehicle width direction Y.

### LIST OF REFERENCE SIGNS

1 Front-end structure
2 Radiator
3 Upper continuous cross member
4 Right-hand vertical strut
5 Left-hand vertical strut
41,51 Vertical upper part of vertical struts
42,52 Vertical lower part of vertical struts
6 Right-hand part of two-part lower cross member
7 Left-hand part of two-part lower cross member
8 Right-hand air guide
9 Left-hand air guide
10 Air flap control
11 Right-hand deformation element
12 Left-hand deformation element
X Motor vehicle longitudinal direction
Y Motor vehicle width direction
Z Motor vehicle height direction

1.-10. (canceled)

11. A front-end structure for a motor vehicle, comprising:
a right-hand deformation element in a motor vehicle width direction;
a left-hand deformation element in the motor vehicle width direction;
a continuous cross member in the motor vehicle width direction, connecting the right-hand and left-hand deformation elements to one another and being arranged in front of the right-hand and left-hand deformation elements in a motor vehicle longitudinal direction;
a further cross member; and
a right-hand vertical strut in the motor vehicle width direction and a left-hand vertical strut in the motor vehicle width direction, connecting the continuous cross member to the further cross member,
wherein the right-hand and left-hand vertical struts are configured in each case to be L-shaped, when viewed from the motor vehicle longitudinal direction.

12. The front-end structure according to claim 11, wherein
an upper part of a respective vertical strut extends vertically in a motor vehicle height direction and a lower part of the respective vertical strut extends horizontally.

13. The front-end structure according to claim 11, wherein
the further cross member is designed in two parts in the motor vehicle width direction.

14. The front-end structure according to claim 13, further comprising:
a radiator which is arranged between the right-hand and left-hand deformation elements in the motor vehicle width direction,
wherein the further cross member is designed in two parts in the motor vehicle width direction, such that each part of the further cross member is arranged exclusively to a side of the radiator in the motor vehicle width direction.

15. The front-end structure according to claim 14, further comprising:
an air flap control; and
a right-hand air guide in the motor vehicle width direction and a left-hand air guide in the motor vehicle width direction,
wherein the left-hand vertical strut in the motor vehicle width direction is arranged in the motor vehicle width direction between the air flap control and the left-hand air guide in the motor vehicle width direction, and
wherein the right-hand vertical strut in the motor vehicle width direction is arranged in the motor vehicle width direction between the air flap control and the right-hand air guide in the motor vehicle width direction.

16. The front-end structure according to claim 15, wherein
the air flap control is arranged below the continuous cross member in the motor vehicle height direction.

17. The front-end structure according to claim 15, wherein
the air flap control is arranged in the motor vehicle width direction between the right-hand air guide in the motor vehicle width direction and the left-hand air guide in the motor vehicle width direction.

18. The front-end structure according to claim 11, wherein
the continuous cross member is arranged above the further cross member in a motor vehicle height direction.

19. The front-end structure according to claim 11, wherein
the vertical struts are arranged in each case in front of the continuous cross member and the further cross member in the motor vehicle longitudinal direction.

20. A motor vehicle comprising the front-end structure according to claim 11.
